(19) United States
(12) Patent Application Publication
(10) Pub. No.: US 2022/0219960 A1
(43) Pub. Date: Jul. 14, 2022

(54) INDUSTRIAL TRUCK

(71) Applicant: HUBTEX MASCHINENBAU GMBH & CO. KG, FULDA (DE)

(72) Inventor: JUERGEN KELLER, GROSSENLUEDER (DE)

(73) Assignee: HUBTEX MASCHINENBAU GMBH & CO. KG, FULDA (DE)

(21) Appl. No.: 17/610,446

(22) PCT Filed: Mar. 12, 2020
(86) PCT No.: PCT/EP2020/056654

§ 371 Date: Nov. 11, 2021

(30) Foreign Application Priority Data
May 14, 2019 (DE) 10 2019 112 582.0

(51) Int. Cl. B66F 9/07

(52) U.S. Cl. CPC B66F 9/07

(57) ABSTRACT

An industrial truck includes a loading platform, masts which are arranged opposed to each other, and a chassis. The masts lift and lower the loading platform which is arranged between the masts in a lifting and lowering direction. The chassis includes two side regions on which the masts are arranged, and at least two cross members which are arranged spaced apart from each other and which connect the two side regions with each other.

### CROSS REFERENCE TO PRIOR APPLICATIONS

This application is a U.S. National Phase application under 35 U.S.C. § 371 of International Application No. PCT/EP2020/056654, filed on Mar. 12, 2020 and which claims benefit to German Patent Application No. 10 2019 112 582.0, filed on May 14, 2019. The International Application was published in German on Nov. 19, 2020 as WO 2020/229020 A1 under PCT Article 21(2).

### FIELD

The present invention relates to an industrial truck comprising opposing masts for lifting and lowering a loading platform which is located between the masts in a lifting and lowering direction, and a chassis that includes two lateral regions on which the masts are arranged.

The present invention in particular relates to an industrial truck which is used to transport air freight shipment pallets or containers.

### BACKGROUND

Such an industrial truck has previously been described under the name “Xway Mover 7000” from the company DIMOS Maschinenbau GmbH. The chassis in this industrial truck is U-shaped and comprises a voluminous cross-bar which is usually arranged at the rear end in the forward travel direction and which connects the two lateral regions to each other. The loading platform in this vehicle can be lowered into regions close to the ground if it does not extend as far as the rear cross-bar. It is, however, generally desirable that loads to be transported, such as air freight shipment pallets or containers, can be pushed onto the loading platform not only from the front, but also from the rear. The loading platform must extend over the rear cross-bar for this purpose, as a result of which the minimum achievable loading and unloading height above the ground is undesirably high.

### SUMMARY

An aspect of the present invention is to provide an industrial truck which has a comparatively low loading and unloading height at the front and at the rear.

In an embodiment, the invention provides an industrial truck which includes a loading platform, masts which are arranged opposed to each other, and a chassis. The masts are configured to lift and to lower the loading platform which is arranged between the masts in a lifting and lowering direction. The chassis comprises two side regions on which the masts are arranged, and at least two cross members which are arranged spaced apart from each other and which are configured to connect the two side regions with each other.

### BRIEF DESCRIPTION OF THE DRAWINGS

The present invention is described in greater detail below on the basis of embodiments and of the drawings in which:

FIG. 1 is a first perspective view of an embodiment of an industrial truck according to the present invention;

FIG. 2 is a second perspective view of the same embodiment;

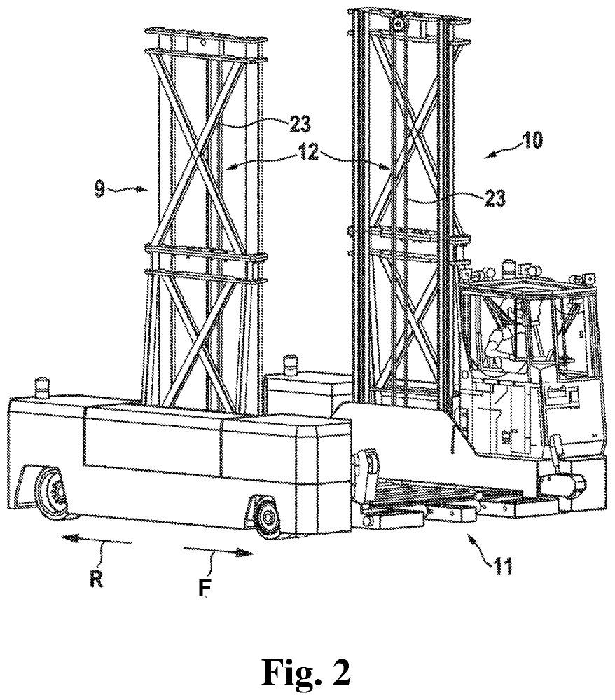

FIG. 3 is a side view of the same embodiment;

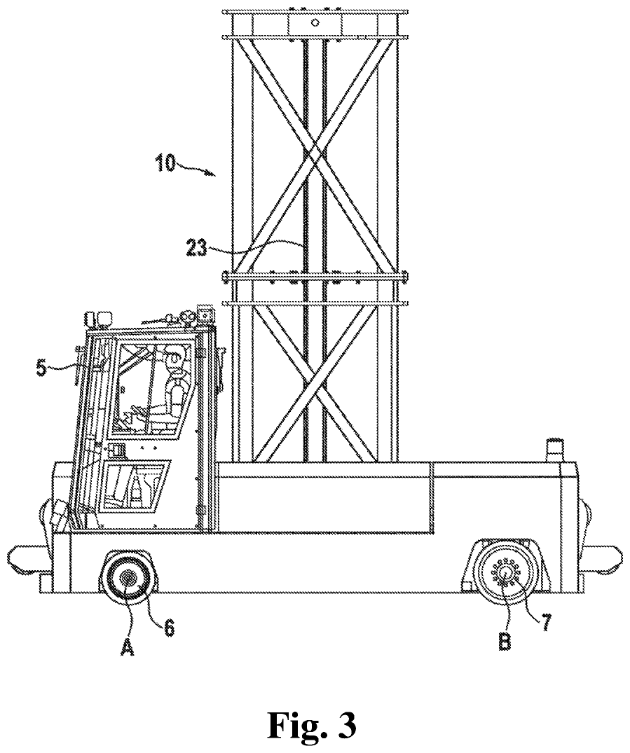

FIG. 4 is a view corresponding to FIG. 2, of the same embodiment, but loaded with a transport container;

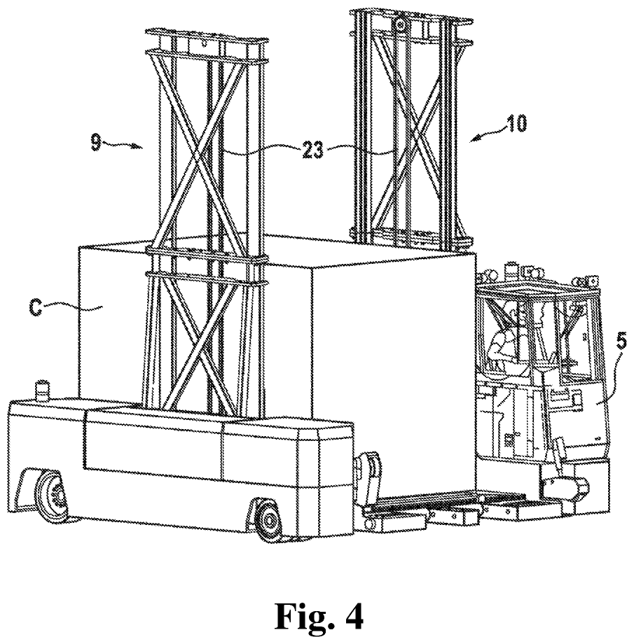

FIG. 5 is a view from below of the same embodiment;

FIG. 6 is a view from above of the same embodiment;

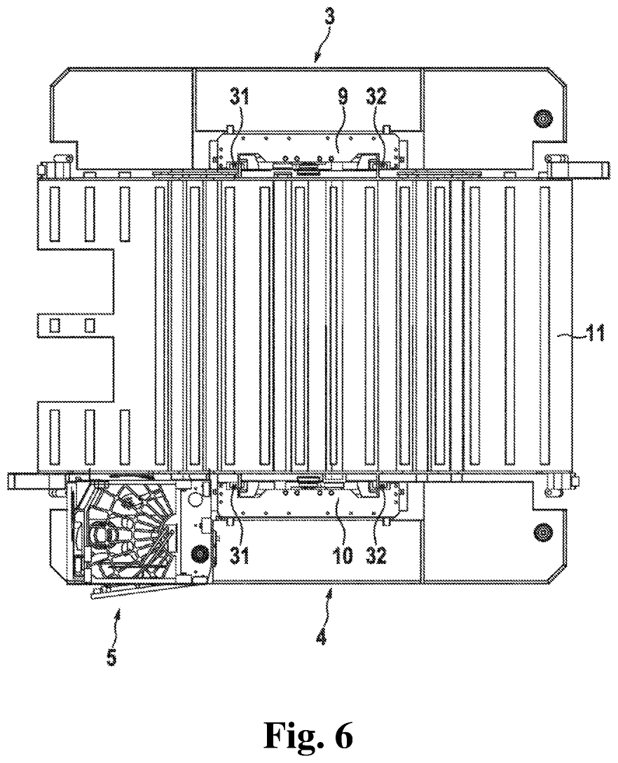

FIG. 7 is a partial view of the same embodiment in a view according to FIG. 1 from the rear;

FIG. 8 is a perspective rear view of a first embodiment of one of the two masts of the industrial truck according to the present invention;

FIG. 9 is a perspective front view of the mast shown in FIG. 8;

FIG. 10 is a frontal view of the front of the same mast;

FIG. 11 is a view of the same mast from above;

FIG. 12 is a detailed view of a drive device of this mast;

FIG. 13 shows a machine element which is rotationally driven via the drive device and which interacts with a flexible pulling device;

FIG. 14 is a perspective rear view of a second embodiment of a mast;

FIG. 15 is a plan view of the front of the same mast;

FIG. 16 is a perspective front view of the same mast;

FIG. 17 is a perspective detail view of the upper region of a mast, and

FIG. 18 is a detail view of the central region of the embodiment of the mast shown in FIGS. 14 to 16.

### DETAILED DESCRIPTION

In the case of the industrial truck according to the present invention, the chassis comprises at least two spaced-apart cross-bars which connect the lateral regions to each other. Due to the plurality of cross-bars now present, the cross sections of the cross-bars can be designed to be smaller than the single rear cross-bar of the industrial truck as described in the prior art.

The chassis of the industrial truck according to the present invention can, for example, be designed so that the cross-bars engage under the lateral regions.

The cross-bars are in particular, for example, arranged so as to extend in parallel with each other.

In a development, the cross-bars can, for example, each have a transverse extension which is greater than the overall height thereof. The minimum loading and unloading height can thereby be again reduced in the industrial truck according to the present invention.

It has been found that sufficiently high torsional rigidities can be achieved if the overall height is between 10% and 50%, for example, between 15% and 30%, for example, approximately 25%, of the transverse extension.

A development of the industrial truck according to the present invention provides that each cross-bar can, for example, comprise two struts extending in parallel with each other. These struts can then, for example, be connected to each other via a connecting plate in order to further increase torsional rigidity.

The struts can, for example, each have a rectangular, for example, a square cross section.

The connecting plate can, for example, further extend over the entire distance between the two lateral regions in order to again improve torsional rigidity.

The minimally achievable loading and unloading height can be further reduced if, for example, the loading platform has recesses for each of the cross-bars on the lower face thereof.

The present invention will be explained is greater detail below under reference to the accompanying drawings.

The embodiment of an industrial truck according to the present invention (hereinafter “industrial truck 100” for short) shown in the drawings comprises a chassis 1 having a loading region 2 which is delimited by side regions 3, 4. Components (not visible in the drawings) which are required for the operation of the industrial truck, for example, energy stores such as fuel tanks and batteries, drive devices for driving and lifting functions, electrical and hydraulic circuits for controlling the driving and lifting performance in an open-loop or closed-loop manner and for steering the industrial truck, etc. are accommodated in the two side regions 3 and 4.

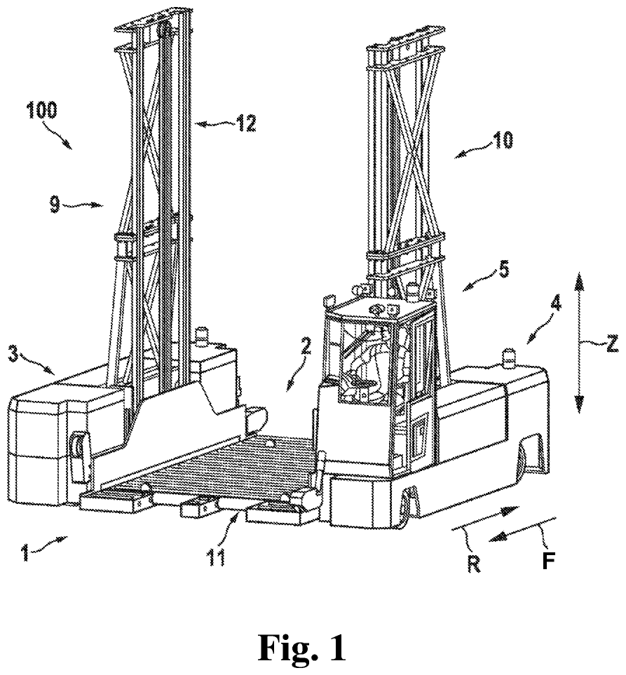

In FIG. 1, the forward and reverse travel directions F, R are symbolized by the arrows F, R.

A driver's cab 5 is arranged in the front region of the left-hand side region 4, as seen in the forward travel direction F. The driver's cab comprises the actuating device required for operating the industrial truck 100, such as buttons, switches, joysticks, and a steering wheel.

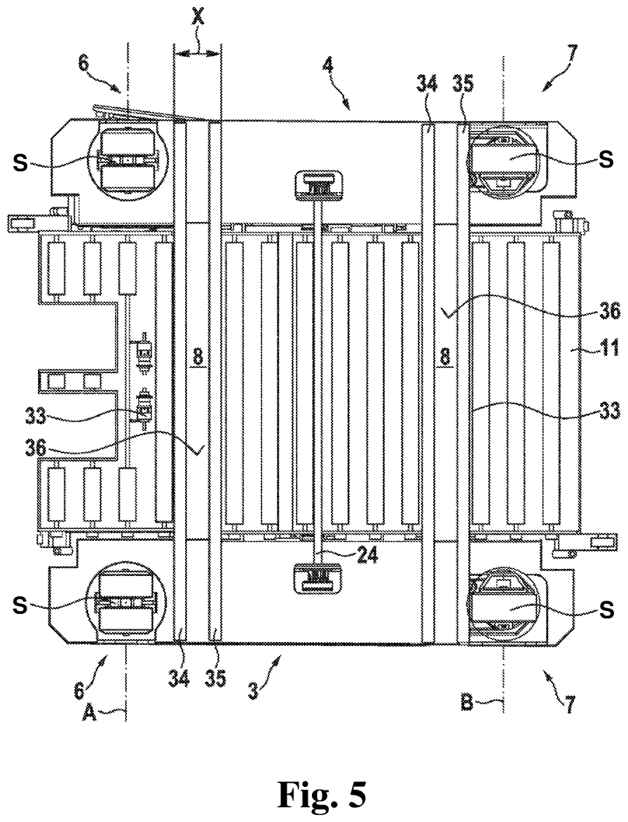

As can be seen in particular in FIG. 5, the industrial truck 100 has four wheels, the front wheels 6 associated with the front axle A being designed as twin wheels, and the rear wheels 7 associated with the rear axle B being designed as single wheels. All of the four wheels are designed to be steerable so that they can be rotated through 360° about their relevant steering axle S. Each of the wheels 6, 7 is connected to its own steering motor (which is not shown in the drawings). All steering motors can, for example, be designed as electric motors and are controlled via a steering computer so that the industrial truck 100 can execute travel direction changes in any sequence without stopping. This means that a loading or an unloading station can be approached directly without complex maneuvering.

At least one of the front wheels 6 and rear wheels 7 is coupled to a travel drive. In order to improve traction, all of the front wheels 6 and rear wheels 7 can, for example, each be coupled to a travel drive. The travel drive(s), like the steering motors, can comprise electric motors.

As can be seen in FIG. 5, the chassis 1 has two cross-bars/cross members 8 which extend in parallel with each other and are arranged between the front axle A and the rear axle B. The cross members 8 connect the lateral regions 3 and 4. The cross members 8 are arranged close to the ground and have a comparatively low overall height Y compared to the transverse extension X, so that a low loading and unloading height H can be achieved in the case of the industrial truck 100, as is explained in greater detail below.

Two masts 9, 10 extend upward from the chassis 1. The mutually facing sides of the masts 9, 10 are arranged so as to be at least almost flush with mutually facing sides of the side regions 3, 4.

The two masts 9, 10 are used to lift and lower a loading platform 11 in a lifting and lowering direction Z. The loading platform 11 is used to carry a load, for example, a container C. Each mast 9, 10 has a flexible pulling device 12 therefor which revolves around a lower pulley 13 and an upper pulley 14. In the shown embodiment, the flexible pulling device 12 comprises two V-belts which extend in parallel with each other. These V-belts are tensioned between the lower and upper pulleys 13, 14, which are here provided as double belt pulleys. While the upper pulley 14 is mounted in a stationary bearing block 15 so as to be freely rotatable about an axis 16, the lower pulley 13 is connected to the drive shaft 17 of a drive device 18 in a rotationally fixed manner. The drive device 18 can, for example, also comprise an electric motor.

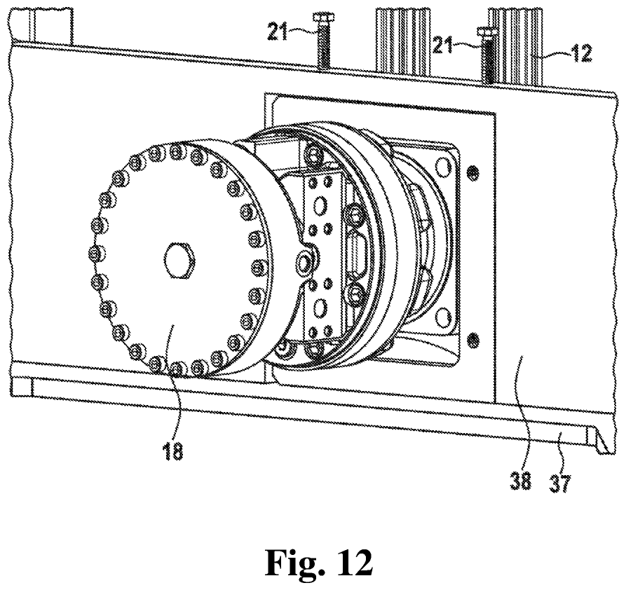

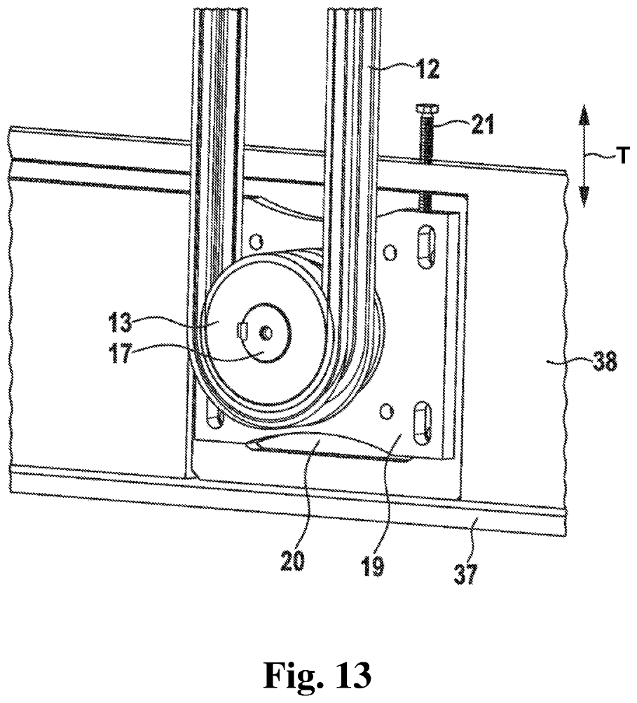

The drive device 18 is mounted on a bearing block 19 which is arranged on the mast 9, 10 so as to be movable for the purpose of adjusting the tension of the flexible pulling device 12 (see in particular FIGS. 12 and 13). The masts 9, 10 each have a bearing block receptacle 20 for this purpose which has a greater extension in the tensioning direction T than the bearing block 19. According to FIGS. 12 and 13, two threaded bores, into each of which a clamping screw 21 is screwed, open into the bearing block receptacle 20 from above. The front end of each of the clamping screws 21 in the screwing-in direction is supported on a surface of the bearing block 19. As is evident from FIGS. 12 and 13, the tension of the flexible pulling device 12 can be changed by screwing in and unscrewing the clamping screws 21.

Due to the revolution around the lower and upper pulleys 13, 14, the flexible pulling device 12 has two strands 22, 23 which extend in parallel with each other. In order for the flexible pulling device 12 of the two masts 9, 10 to rotate at exactly the same speed, the drive shafts 17 of the two drive devices 18 of the masts 9, 10 can, for example, be mechanically connected to each other via a connecting shaft 24 (see FIG. 5). By providing a connecting shaft 24, it is in principle also possible to provide only a single drive device 18 for the flexible pulling device 12 of the two masts 9, 10.

For the purpose of lifting and lowering, the loading platform 11 is connected to one of the two strands 22, 23 of the two flexible pulling devices 12 of the masts 9, 10, for example, to strand 23 in each case, which strands run in the same direction when the drive devices 18 are actuated.

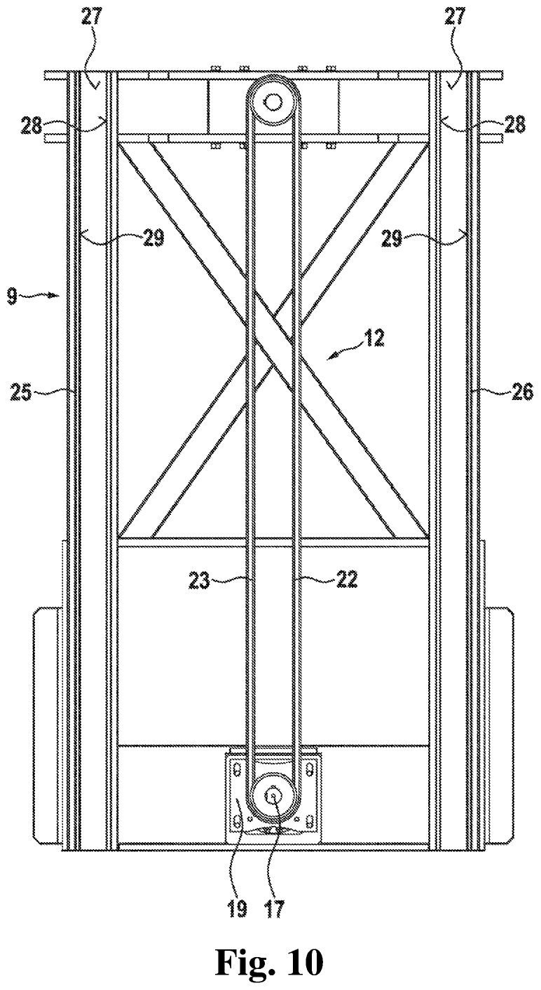

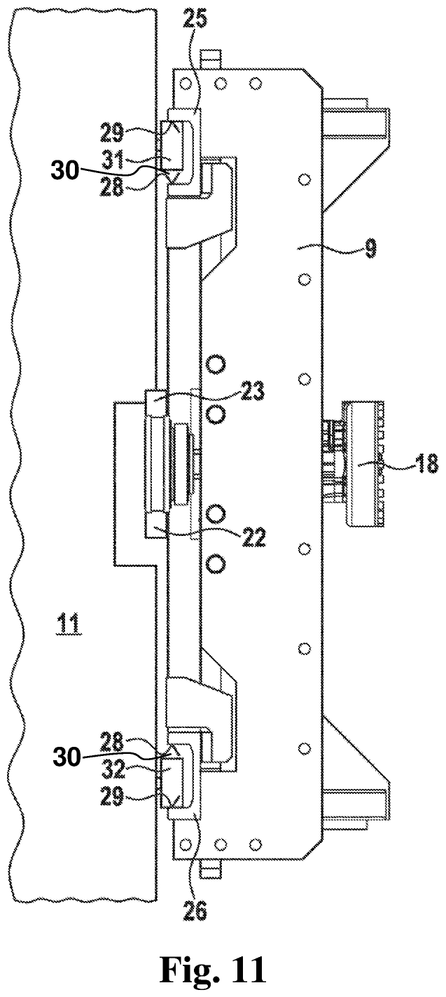

In order to guide the loading platform 11 on the masts 9, 10, guide profiles 25, 26 are provided on the masts 9, 10, as can in particular be seen in FIGS. 10 and 11 in the example of mast 9. Each guide profile 25, 26 has an internal cross section which is approximately C-shaped. This cross section has a base surface 27 and two mutually parallel side surfaces 28, 29 which extend perpendicular from the base surface 27 to an open profile side 30.

The guide profiles 25, 26 are arranged on the relevant mast 9, 10 so that their open profile sides 30 face each other.

As can be seen in FIG. 11, the loading platform 11 has two guide rollers 31, 32 on its side facing the mast 9, which guide rollers 31, 32 in the shown embodiment each roll on one of the two outer lateral surfaces 29 of the guide profiles 25, 26 and thus guide the guide platform 11 to prevent movements relative to the mast 9 in the F-R direction of the industrial truck 100. The loading platform 11 can of course also be formed correspondingly on the side (not shown in FIG. 11) facing the other mast 10. The mast 10 also has guide profiles 25, 26. It should finally be noted that the guide rollers 31, 32 can also be arranged so that they both roll on the central side surfaces 28 of the guide profiles 25, 26. Further guide rollers (not shown in the drawings) can also be provided which are offset in the longitudinal direction of the guide profiles 25, 26 with respect to the guide rollers 31, 32, which further guide rollers in turn roll on one of the side surfaces 28 or 29. The loading platform can as a result also be secured against tilting in an axis extending perpendicular to the plane of the drawing in FIG. 10 via the guide profiles 25, 26.

A significant advantage of the design and arrangement of the guide profiles 25, 26 and the guide rollers 31, 32 rolling therein is that forces acting on the loading platform 11 in the F-R direction, as can occur in particular during loading and unloading, are directly absorbed by the two masts 9, 10 and that no further, possibly technically complex, measures are required therefor.

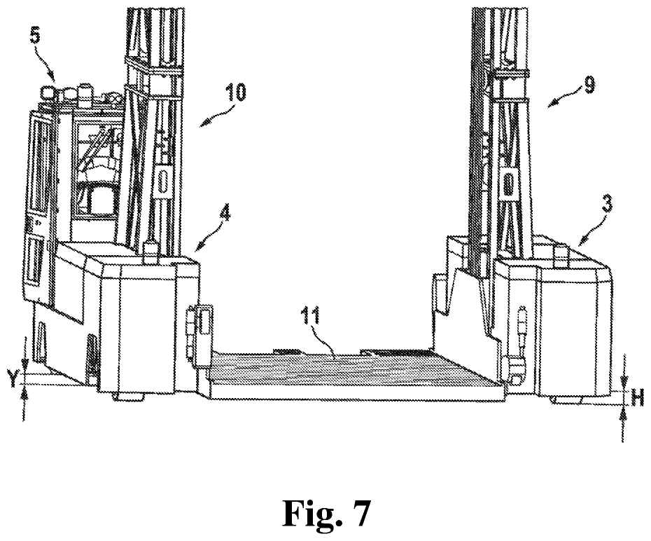

As already mentioned above, the industrial truck 100 has a particularly low loading and unloading height H. As can be seen in FIG. 7, this is substantially identical on the front axle side and rear axle side. This is caused by the design of the chassis 1 with cross members 8 in contrast to the known U-shaped design of the chassis 1 with a single rear cross member 8 which, in order to achieve the required chassis rigidity, must have a considerably more voluminous cross section than the two cross members 8 which are spaced apart from each other in the longitudinal extension of the industrial truck 100. In order to be able to minimize the loading and unloading height H, the loading platform 11 has recesses 33 for each of the cross members 8 on the lower face thereof, so that the loading and unloading height H only slightly exceeds the vertical extension of the cross member 8 from the ground.

Each of the cross members 8 can comprise two struts 34, 35 which extend in parallel with each other and which have a rectangular, for example, a square cross section. The struts 34, 35 are connected to each other by a connecting plate 36.

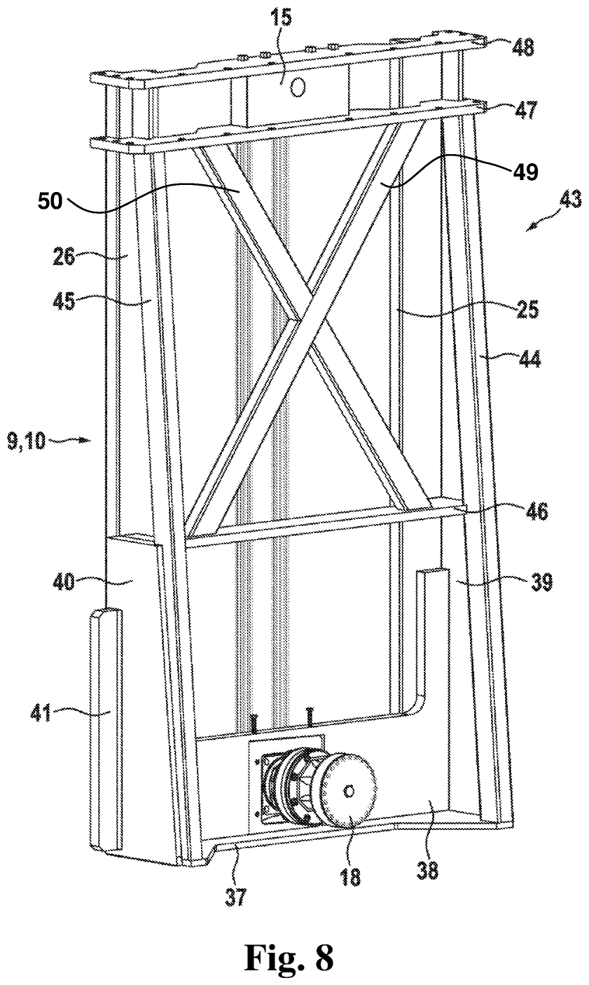

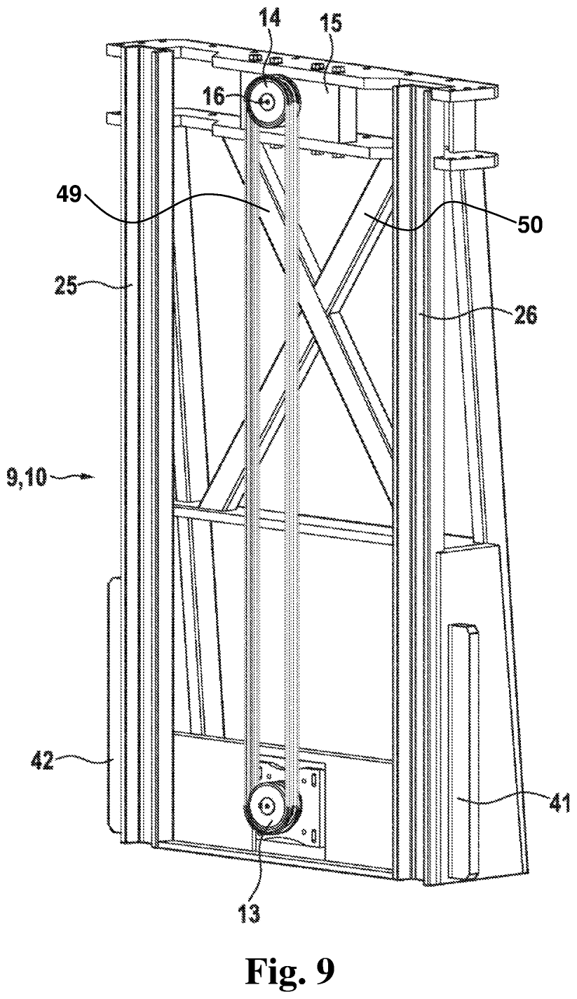

As can be seen, for example, in FIGS. 8 and 9, the masts 9, 10 each have a base plate 37 from which a lower frame component 38, which comprises the bearing block receptacle 20, extends upward. The lower frame component 38 is approximately U-shaped when viewed from the front or the rear of the mast 9, 10. Side walls 39, 40 of the mast, which are provided with lateral stiffening ribs 41, 42, rest on the outer faces of the two legs of the lower frame component. A first main frame 43, which comprises lateral profiles 44, 45 which are connected to each other via cross struts 46, 47, 48, extends upward from the base plate 37. Diagonal strutting 49, 50 which is arranged in an X-like manner extends between the lower cross strut 46 and the central cross strut 47. The guide profiles 25, 26 are attached to the base plate 37, the side walls 39, 40, and the cross struts 46, 47, 48. The so constructed mast is characterized by considerable torsional rigidity combined with low weight and low manufacturing costs.

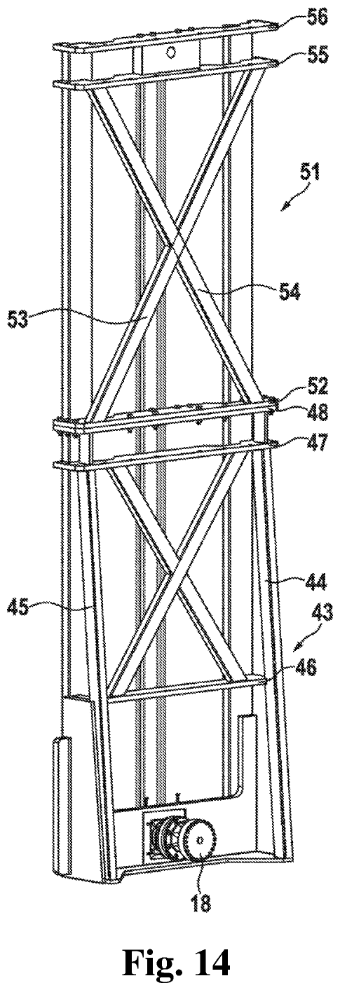

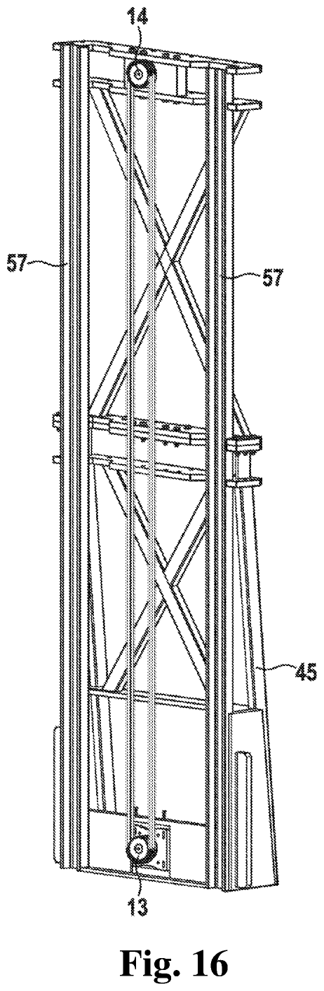

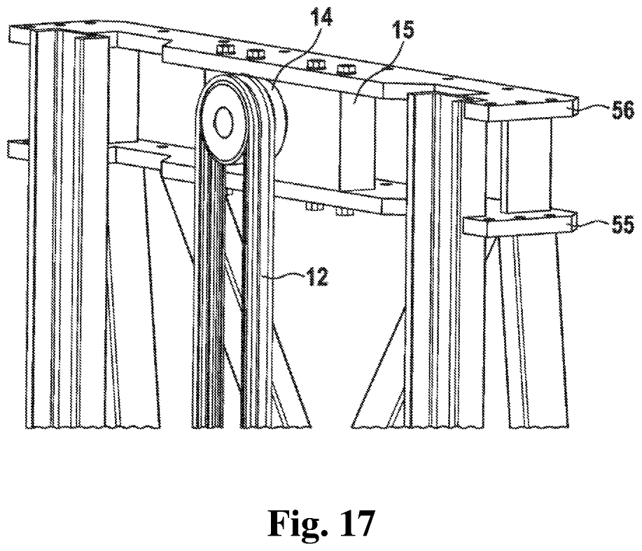

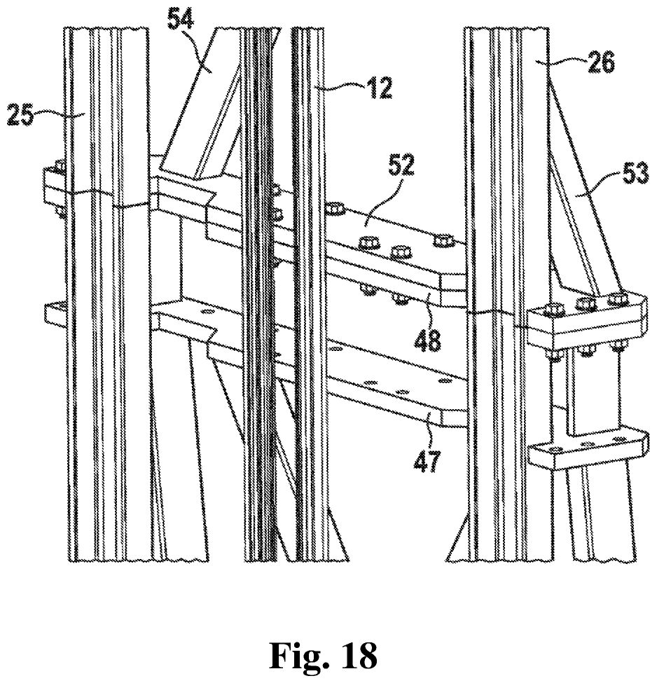

In the embodiment of the mast shown in FIGS. 8, 9 and 10, the upper bearing block 15 is arranged between the central cross strut 47 and the upper cross strut 48. As can be seen by comparison with the further embodiment of a mast 9, 10 shown in FIGS. 14 to 18, the bearing block 15 between the cross struts 47 and 48 is missing in this further embodiment. A second main frame 51 instead extends upward from the upper cross strut 48. The second main frame 51 has a lower cross strut 52 which is screwed to the upper cross strut 48 of the first main frame 43. A central cross strut 55 is connected to the lower cross strut 52 via diagonal strutting 53, 54. The bearing block 15 is arranged between this central cross strut and an upper cross strut 56. The guide profiles 25, 26 extend from the base plate 37 to the cross strut 56; the guide profiles 25, 26 are, for example, formed to be longer in the mast shown in FIGS. 14 to 18 than the guide profiles shown in FIGS. 8 to 10 by adding guide profile portions 57. The flexible pulling device 12 accordingly also has a greater length in the embodiments shown in FIGS. 14 to 18 than in those shown in FIGS. 8 to 10.

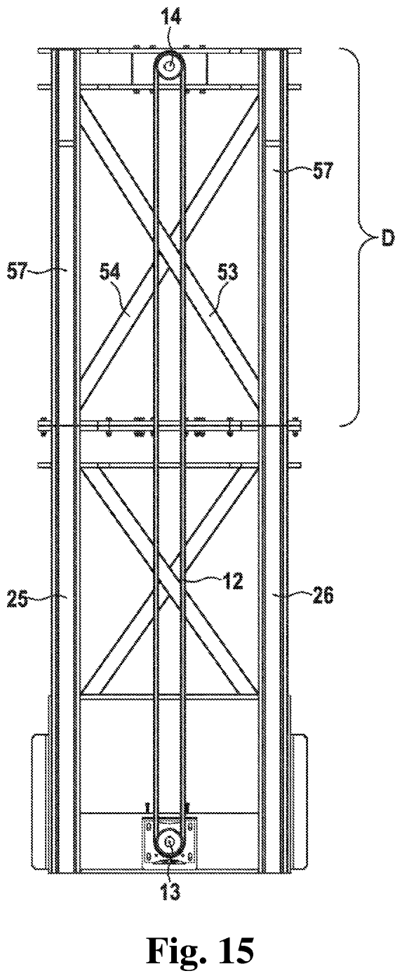

From the above explanations, it can be seen that, due to the modular design of the mast with a variable number of diagonal strutting and cross struts, it is possible to easily provide masts of different lengths that are adapted to user requirements. It can further be seen that, due to this modular design, existing industrial trucks having corresponding masts can be adapted to changing requirements with minimal effort with respect to the maximum lifting height that can be achieved therewith. For this purpose, only segments, as denoted by D in FIG. 15, together with the associated guide profile portions 57 of the relevant mast 9, 10 must be removed or added, and the flexible pulling device 12 must be replaced by one of a suitable length.

The present invention is not limited to embodiments described herein; reference should be had to the appended claims.

### LIST OF REFERENCE NUMERALS

100 Industrial truck
1 Chassis
2 Loading region
3 Side region
4 Side region
5 Driver's cab
6 Front wheels
7 Rear wheels
8 Cross-bar/Cross member
9 Mast
10 Mast
11 Loading platform
12 Flexible pulling device
13 Lower pulley
14 Upper pulley
15 (Upper) Bearing block
16 Axis
17 Drive shaft
18 Drive device
19 Bearing block
20 Bearing block receptacle
21 Clamping screw
22 Strand
23 Strand
24 Connecting shaft
25 Guide profile
26 Guide profile
27 Base surface
28 (Central) Side surface
29 (Outer) Side surface
30 Open profile side
31 Guide roller
32 Guide roller
33 Recesses
34 Strut
35 Strut
36 Connecting plate
37 Base plate
38 Lower frame component
39 Side wall
40 Side wall
41 Stiffening rib
42 Stiffening rib
43 First main frame
44 Lateral profile
45 Lateral profile
46 Cross strut
47 Central cross strut
48 Upper cross strut
49 Diagonal strutting
50 Diagonal strutting
51 Second main frame
52 Lower cross strut
53 Diagonal strutting
54 Diagonal strutting
55 Central cross strut
56 Upper cross strut
57 Guide profile portion
A Front axle
B Rear axle
C Container
D Segment
H Loading and unloading height
S Steering axles
R Reverse direction of travel
T Tensioning direction
F Forward direction of travel
X Transverse extension
Y Overall height
Z Lifting and lowering direction

What is claimed is:

1-10. (canceled)

11. An industrial truck comprising:
a loading platform;
masts which are arranged opposed to each other, the masts being configured to lift and to lower the loading platform which is arranged between the masts in a lifting and lowering direction; and
a chassis comprising two side regions on which the masts are arranged, and at least two cross members which are arranged spaced apart from each other and which are configured to connect the two side regions with each other.

12. The industrial truck as recited in claim 11, wherein the at least two cross members are configured to engage under the two side regions.

13. The industrial truck as recited in claim 11, wherein the at least two cross members are arranged to be parallel with respect to each other.

14. The industrial truck as recited in claim 11, wherein,
each of the at least two cross members comprise a transverse extension and an overall height, and
the overall height is less than the transverse extension.

15. The industrial truck as recited in claim 14, wherein the overall height is from 10% to 50% of the transverse extension.

16. The industrial truck as recited in claim 14, wherein the overall height is from 15% to 30% of the transverse extension.

17. The industrial truck as recited in claim 14, wherein the overall height is 25% of the transverse extension.

18. The industrial truck as recited in claim 11, wherein each of the at least two cross members comprises two struts which are arranged to be parallel with respect to each other.

19. The industrial truck as recited in claim 18, further comprising:
a connecting plate,
wherein,
the two struts are further connected to each other via the connecting plate.

20. The industrial truck as recited in claim 19, wherein the connecting plate extends over an entire distance between the two side regions.

21. The industrial truck as recited in claim 18, wherein the two struts each comprise a rectangular cross section.

22. The industrial truck as recited in claim 18, wherein the two struts each comprise a square cross section.

23. The industrial truck as recited in claim 11, wherein the loading platform comprises recesses for each of the at least two cross members on a lower face thereof.
